(19) United States
(12) Patent Application Publication
(10) Pub. No.: US 2025/0141150 A1
(43) Pub. Date: May 1, 2025

(54) ADD-ON HOUSING WITH SEAL

(71) Applicant: HARTING ELECTRIC STIFTUNG & CO. KG, Espelkamp (DE)

(72) Inventors: Stefan WATTENBERG, Espelkamp (DE); Markus BEE, Espelkamp (DE)

(21) Appl. No.: 18/919,256

(22) Filed: Oct. 17, 2024

(30) Foreign Application Priority Data
Oct. 27, 2023 (DE) 102023129757.0

(51) Int. Cl. H01R 13/52; H01R 13/64; H01R 43/00; H01R 43/18

(52) U.S. Cl. CPC H01R 13/5202; H01R 13/64; H01R 43/005; H01R 43/18

(57) ABSTRACT

An electrical add-on housing for accommodating an electrical high-current plug connector is provided, including at least one housing, an electrical contact element and a sealing element. The housing has a device side and a plug-in side. A stop is arranged circumferentially on the housing and the plug-in side has at least one fastening device, which is brought into engagement with a fastening form of the high-current plug connector. The plug-in side also has at least one device for coding, which prevents a plug-in process with an unsuitable plug connector or prevents a plug-in process with the high-current plug connector in an undesired orientation. The sealing element may be designed as a one-piece, substantially hollow-cylindrical sleeve with a sealing flange and at least one circumferential sealing contour.

### BACKGROUND

### Technical Field

The present disclosure relates to an add-on housing with seal.

Such add-on housings are required to enable an electrical connection from an electrical conductor, such as an insulated electrical cable, into a device, for example transformers, energy storage devices, working machines, switch cabinets and/or working machines.

### Description of the Related Art

In the prior art, add-on housings are known in many variants and in large numbers. Even in the case of single-wire connectors, there are add-on housings that can fulfil a variety of different functions.

A disadvantage of known solutions is insufficient impermeability to foreign media, especially fluids. This disadvantage is unfavorable if a device for coding, i.e., for preventing incorrect/unwanted plug connections or the incorrect/unwanted alignment of correct plug connectors, is arranged on the inside of the add-on housing.

### BRIEF SUMMARY

Embodiments of the present disclosure provide an electrical add-on housing for individual conductors with a device for coding, which add-on housing is advantageously protected by a sealing element against the ingress of foreign media in a space-saving manner.

Embodiments of the present disclosure further provide a plug connector system with an add-on housing described herein provided with a sealing element.

A method for producing an add-on housing with sealing element is also provided.

The present disclosure provides an electrical add-on housing for accommodating an electrical high-current plug connector, including at least one housing, an electrical contact element and a sealing element. The housing has a device side and a plug-in side. A stop is arranged circumferentially on the housing and the plug-in side has at least one fastening device, which is brought into engagement with a fastening form of the high-current plug connector. The plug-in side also has at least one device for coding, which prevents a plug-in process with an unsuitable plug connector or prevents a plug-in process with the high-current plug connector in an undesired orientation. The sealing element may be designed as a one-piece, substantially hollow-cylindrical sleeve with a sealing flange and at least one circumferential sealing contour.

The “add-on housing” is therefore to be understood as a device which is designed to enable an electrical connection from a device, for example a working machine, a switch cabinet, a transformer or an energy storage device, to an electrical line, such as an electrical cable.

In the context of the present disclosure, the term “high-current plug connector” refers to a plug connector that can be connected to the connection housing and is designed to transmit high currents. This means currents of greater than or equal to 50 amperes (A), preferably greater than or equal to 120 A, in some embodiments greater than or equal to 200 A and in some embodiments even greater than or equal to 400 A.

The term “housing” is to be understood as any designed enclosure and/or outer casing which surrounds and/or accommodates a contact element to the greatest possible extent to protect against touching or contact with foreign media. In some embodiments, the housing may be designed to be guided through a wall of a previously mentioned device, wherein the interior of the device preferably remains protected from foreign media such as dust, dirt or fluids such as oil or water. For this purpose, various seals may be provided in, around or on the housing, which are used for sealing between the device wall and the housing. The housing may substantially be divided into two areas: a plug-in side and a device side. The plug-in side is designed to be connected to a high-current plug connector and has a fastening device which can be brought into engagement with a corresponding fastening form arranged on the high-current plug connector. The device side is designed to be at least partially inserted into the corresponding device. In some embodiments, the side of the device may have a fixing form which allows the add-on housing to be connected to the device wall. Suitable fixing forms include threads, such as external threads, latching hooks or openings for connection elements such as screws, bolts or rivets.

The term “contact element” refers to an electrically conductive component that is at least partially arranged in the housing. In some embodiments, the contact element of the add-on housing may be a pin contact that has a contact protection device or means at its plug-in end to protect it from being touched by a person.

The term “sealing element” refers to a device for sealing the add-on housing against foreign media, such as dust, dirt and/or fluids such as water, oils or comparable operating media. On the one hand, the sealing element should be suitable for protecting the device on which the add-on housing is arranged. On the other hand, the area in which the electrical connection between the add-on housing and the high-current plug connector is made when they are plugged together should be protected in a sealed manner.

A “stop” may be a molded element on the housing that is suitable for limiting insertion into the device. Ring-shaped or disc-shaped moldings and/or attachments may be used here. These stops often allow the inclusion of a seal, for example an O-ring, to protect the device from the ingress of foreign media around the add-on housing. Furthermore, the stop enables the add-on housing to be securely fastened, for example by bringing a fixing element, such as a union nut, from inside the device onto a fixing form, such as a thread, of the housing and engaging with each other there.

The terms “fastening device” and “fastening form” refer to corresponding elements on the add-on housing or high-current plug connector, which are designed to engage with each other in order to secure a mechanical connection. For example, latching hooks may be inserted into latching recesses, preferably in a reversible design, such as push-pull latches, push-push latches, or elements such as bayonet latches, screw connections or locking levers are used. In this case, the fastening device is initially assigned to the add-on housing and the fastening form to the high-current plug connector, but a fastening form on the add-on housing and a fastening device on a high-current plug connector are also meant.

The term “device for coding” refers to a device that enables a high-current plug connector to be clearly assigned to an add-on housing. This is intended to prevent or at least hinder the plugging of unsuitable plug connectors with the add-on housing. This coding can and should also prevent or at least make it more difficult to plug in a correct high-current plug connector, albeit in an undesired orientation.

In one embodiment, the sealing contour may be arranged as an annular molding on the outside of the sealing element. The sealing contour in some embodiments may be designed as a circumferential lamella. The sealing contour should therefore be designed as a thin-walled ring around the sleeve of the sealing element. This is intended to enable the sealing element, or more precisely the lamella, to compensate for and seal a device for coding that is otherwise disadvantageous for the seal in a simple but helpful manner. In some embodiments, the sealing contour may be arranged on the sleeve at least in duplicate, at different distances along the longitudinal axis of the sleeve. In some embodiments, the sealing contour may be arranged in triplicate along the longitudinal axis of the sleeve. A quadruple or even multiple versions of the sealing contour along the longitudinal axis of the sleeve is also conceivable.

In one embodiment, a flange outer diameter of the sealing flange may measure at least 80% of the inner diameter of the device side. In some embodiments, the sealing flange may be designed with a flange outer diameter that measures 90% of the inner diameter of the device side. In one embodiment, the flange outer diameter fills 100% of the inner diameter of the device side. This means that the sealing flange fits as closely as possible to the inside of a wall of the add-on housing. In a design with an 80% diameter match, complete sealing can be achieved, for example, by exerting pressure on the sealing flange through a plug connector housing of the high-current plug connector when the add-on housing and high-current plug connector are plugged in, so that the sealing flange fits to the inside of the wall under elastic deformation.

In one embodiment, at least the sealing flange may be made of an elastic material, which may be connected to the inside of the add-on housing by an integral bond. In some embodiments, the sealing element may be made of an elastic material, wherein at least the sealing flange is integrally bonded to the inside of the add-on housing, such as the inside of the device side. In one embodiment, the sealing element may be joined to the wall of the inside of the add-on housing using a joining process, such as adhesive bonding. In one embodiment, the seal may be inserted into the add-on housing using a molding process. Casting processes, such as die casting or injection molding, are suitable for this purpose. In some embodiments, the sealing element may be molded around the contact element in the add-on housing using a low-pressure casting process, such as by overmolding.

In one embodiment, the sealing contour may be brought into sealing engagement with an inner wall of the high-current plug connector. In other words, the sealing contour, in some embodiments, may be designed as a double or multiple lamella, and fit tightly against the inner wall of the high-current plug connector. This substantially protects the contact element and a contact socket of the high-current plug connector, which is brought into an electrically conductive connection with the contact element, against the ingress of foreign media. The sealing element can be arranged particularly advantageously around a device for coding arranged on the inside, wherein the seal against foreign media can be achieved by the sealing contour, which is arranged circumferentially around one or more areas of the sleeve and extends radially from these areas in order to make mechanical contact with the inner wall of the high-current plug connector.

In one embodiment, the sealing contour may have a contour outer diameter that is smaller than the flange outer diameter. In this way, it is possible to influence how the intended design of the high-current plug connector is to be accommodated. For example, if the plug connector housing has a wide wall, a smaller outer contour diameter may be selected than is necessary with a thinner wall in order to expediently achieve a seal against foreign media.

In one embodiment, the sealing contour may flexibly accommodate or enclose the device for coding and seal it against foreign media. This means that the sealing contour may deform elastically around an internal device for coding so that the desired tightness is achieved. It also means that, in the case of a sealing element introduced by molding, the device for coding may be bypassed from the outset in such a way that the sealing contour encloses the device, surrounds the device, or can ignore the device by a correspondingly elastic design.

In one embodiment, the contact element may have a connection area, a contact area and a fixing area, wherein the connection area is separated from a contact area by a fixing area and wherein the contact area is substantially cylindrical. The connection area is to be understood here as the area of the contact element arranged inside the device, which is designed to be connectable to a conductor and/or cable inside the device. The contact area is designed to establish an electrically conductive connection with a plug connector contact. In some embodiments, the contact area may be cylindrical, i.e., ideally designed as a pin contact. The fixing area is to be understood as a form that enables the contact element to be fixed around a housing, in some embodiments by a casting process. For this purpose, moldings such as a bead, a radial spring, a circumferential ring or a comparable shaping are just as conceivable as bolts, pins, threads or hooks. Recesses are also conceivable as possible forms for the fixing area, such as grooves, through-holes, blind holes, notches or incisions.

In one embodiment, the contact element may have a contact protection lock, which may be designed for fastening a contact protection means. Various moldings can be used here, which improve and/or facilitate latching, bonding, pressing, screwing or comparable integrally bonded, form-fitting or frictionally engaged connections between the contact protection device or means and the contact element.

In one embodiment, the sealing element with the sealing flange may be arranged on the fixing area and the sleeve encloses at least a quarter of the length of the contact area.

In one embodiment, the sealing element may be introduced into the housing in a primary forming process. An alternative embodiment provides for the sealing element to be molded onto the contact element in a primary forming process. Some embodiments may allow the housing and/or the contact element to be prepared so that a subsequent assembly of the contact element and housing produces an add-on housing according to the disclosure.

Embodiments of the present disclosure provide a plug connector system including an electrical add-on housing and a corresponding electrical high-current plug connector, wherein the add-on housing has a fastening device which accommodates a fastening form of the high-current plug connector in order to enable mechanical securing of the electrical connection, and wherein the add-on housing has a housing and a contact element, wherein the housing is formed around the contact element in a primary forming process and the high-current plug connector has a plug connector housing and a plug connector contact, wherein the plug connector housing is formed around the plug connector contact in a primary forming process, and wherein the add-on housing has a sealing element which has at least one sealing flange, a sleeve and at least one sealing contour, wherein the sealing element is molded into the add-on housing by a primary forming process, or wherein the add-on housing has a sealing element which has at least one sealing flange, a sleeve and at least one sealing contour, wherein the sealing element is molded onto the contact element by a primary forming process.

In one embodiment, the sealing element may enclose a device for coding, which may be arranged in at least one of the components of the add-on housing or high-current plug connector, in a sealing manner against foreign media or accommodates the device for coding in a sealing manner against foreign media.

The present disclosure provides a method for producing an add-on housing for receiving an electrical high-current plug connector, wherein the add-on housing includes at least a housing, an electrical contact element and a sealing element, wherein the housing includes a device side and a plug-in side, wherein a stop is circumferentially arranged on the housing and the plug-in side includes at least one fastening device which is brought into engagement with a fastening form of the high-current plug connector, and wherein the plug-in side further includes at least one device for coding which prevents a plug-in process with an unsuitable plug connector or a plug-in process with the high-current plug connector in an undesired orientation, and wherein the sealing element is introduced between the housing and the contact element in a primary forming process and is designed elastically in such a way that the device for coding is sealingly received or sealingly enclosed.

### BRIEF DESCRIPTION OF THE SEVERAL VIEWS OF THE DRAWINGS

The present disclosure is shown in the drawings and is explained in more detail below.

FIG. 1 shows a plug connector system in a sectional view along a length of a plug connector system.

FIG. 2 shows a detailed view of the arrangement of a sealing element in an add-on housing in a sectional view.

Some of the figures contain simplified, schematic representations. In some cases, identical reference signs are used for identical but possibly not identical elements. Different views of the same elements may be scaled differently. Directional indications such as “left,” “right,” “top” and “bottom” are to be understood with reference to the respective figure and may vary in the individual illustrations in relation to the object shown.

### DETAILED DESCRIPTION

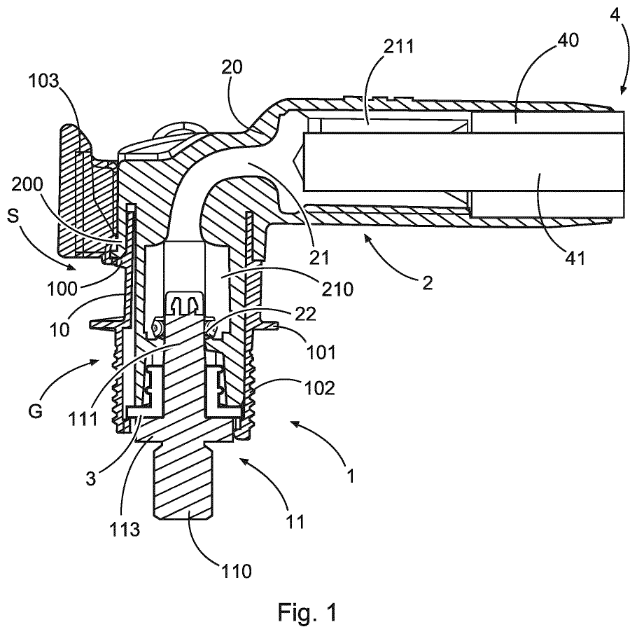

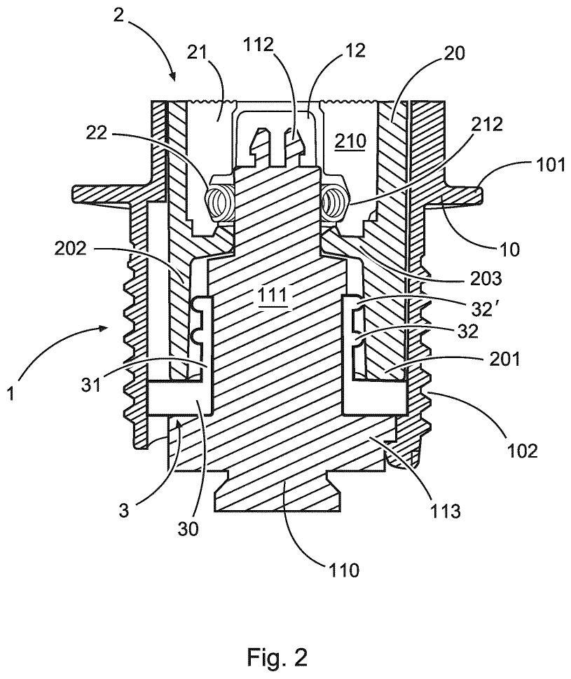

FIG. 1 and FIG. 2 show an add-on housing 1 according to an embodiment of the present disclosure, which is connected to a high-current plug connector 2, wherein a sealing element 3 is arranged in the add-on housing 1 in such a way that, in the plugged-in state shown, a housing 10 and a plug connector housing 20 are sealed against the ingress of foreign media. The detail in FIG. 2 focuses on the sealing element 3. The high-current plug connector 2 is angled and accommodates an electrical line 4. The add-on housing 1 is substantially divided into two areas, namely a device side G and a plug-in side S. The housing 10 has a fastening device 100, which enables mechanical fastening with a fastening form 200. Furthermore, a stop 101 ensures that the add-on housing 1 can be sensibly mounted in a wall of a device, for example a working machine, a switch cabinet, a transformer or an energy storage unit. In some embodiments, a seal, for example an O-ring, may be associated with the stop 101 pointing towards the device side G in order to protect the interior of the device from the ingress of foreign media. In order to fasten the add-on housing 1 to a wall of a device, the housing 10 has a housing fastening form 102 on the device side G. An external thread is shown in FIGS. 1 and 2, although alternatives such as latching hooks, grooves, springs, curved tracks or similar elements are conceivable. Furthermore, a release device 103 is arranged on the plug-in side S of the housing 10 and is designed to release the mechanical fastening of the fastening device 100 with the fastening form 200 when actuated. A contact element 11 is arranged in the housing 10. The contact element 11 is substantially fastened in the device side G, but may, as shown, project beyond the stop 101 located on the outside of the housing 10 into the plug-in side S, depending on the embodiment. The contact element 11 is substantially divided into the areas of connection area 110, contact area 111 and fixing area 113. In the illustrated embodiment, a contact protection lock 112 is arranged facing the contact area 111 in the direction of the plug-in side S. This contact protection lock 112, as well as the contact protection device or means 12 in engagement with it, are more clearly recognizable in FIG. 2. The contact protection lock 112 is designed in such a way that a contact protection device or means 12 may be arranged at the described end of the contact element 11. A design comprising at least two latching hooks arranged substantially opposite one another is shown. Alternatively, a single pin with a (partially) conical extension may be selected in order to simplify production in a rotary process. The high-current plug connector 2 has a plug connector housing 20, one end of which can be connected to the add-on housing 1 and the other end of which can be connected to a line 4. A cable may be used as line 4 and has at least one outer insulation 40 and at least one conductor 41. The plug connector housing 20 in turn has a fastening form 200, which can be brought into engagement with the fastening device 100 of the add-on housing 1. The plug connector housing 20 also has an end face 201, which is inserted into the add-on housing 1. An inner wall 202 is brought into sealing contact with the sealing element 3. A contact receptacle 203 is intended on the one hand to secure a plug connector contact 21 of the high-current plug connector 2 and to protect a contact socket 210 from accidental contact by a person. The contact socket 210 may be designed to make electrical contact with the contact area 111 of the contact element 11. A conductor receptacle 211 is arranged at an opposite end of the plug connector contact 21 and may be designed to accommodate the line 4, such as the electrical conductor 41 located therein. In addition, a fuse holder 212 is provided inside the contact socket 210 and accommodates a contact fuse 22 to ensure the electrical connection between the contact element 11 and the plug connector contact 21 even under load, for example vibration. Lastly, the sealing element 3 with its various areas is visible. The sealing element 3 has a sealing flange 30, which is arranged on a sleeve 31. A sealing contour 32 is may be molded onto the sleeve 31 and is supported by a further sealing contour 32′ in the example shown. The sealing contours 32 and 32′ are offset along the length of the sleeve 31. The sealing element 3 is designed as a single piece. Advantageously, the sealing element 3 may be molded around the contact element 11 in a primary forming process, such as in an injection molding process, such as an overmolding process. The combination of contact element 11 and sealing element 3 is then completed with the housing 10 in a molding process to form the add-on housing 1. Alternatively, to first provide the contact element 11 with the housing 10, whether by an assembly process or, again in some embodiments, by a primary forming process, such as suitable and/or stated casting processes. The combination of housing 10 and contact element 11 is then provided with the sealing element 3, which is inserted into the housing 10 by one of the aforementioned methods or a comparable method.

Details of this embodiment are shown more clearly in FIG. 2. The high-current plug connector 2 is merely indicated, wherein the areas relevant to the present disclosure can be recognized. The end face 201 of the plug connector housing 20 achieves a first sealing effect, at least in part, with the sealing flange 30. The sealing contours 32 and 32′ nestle against the inner wall 202 of the plug connector housing 20 and are also able, due to the redundant design, to sealingly accommodate and/or enclose moldings, such as those provided as a device for coding. In one design, the sealing element 3 may be molded into an existing combination of housing 10 and contact element 11. This ensures, among other things, that the sealing flange 30 is flush, even integrally bonded, with the housing 10, the contact element 11 or both.

Even if various aspects or features of the invention are shown in combination in the figures, it is apparent to a person skilled in the art—unless otherwise stated—that the combinations shown and discussed are not the only possible ones. In particular, corresponding units or feature complexes from different embodiments can be interchanged with one another. In other words, aspects of the various embodiments described above can be combined to provide further embodiments.

German patent application no. 10 2023 129 757.0 filed Oct. 27, 2023, to which this application claims priority, is hereby incorporated herein by reference, in its entirety.

In general, in the following claims, the terms used should not be construed to limit the claims to the specific embodiments disclosed in the specification and the claims, but should be construed to include all possible embodiments along with the full scope of equivalents to which such claims are entitled.

1. An electrical add-on housing for accommodating an electrical high-current plug connector, comprising:
at least one housing;
an electrical plug-in contact; and
a sealing element,
wherein the at least one housing has a device side and a plug-in side,
wherein a stop is arranged circumferentially on the housing and the plug-in side has at least one fastening device, which is configured to be brought into engagement with a fastening form of the high-current plug connector,
wherein the plug-in side further has at least one device for coding, which prevents a plug-in process with an unsuitable plug connector or prevents a plug-in process with the high-current plug connector in an undesired orientation, and
wherein the sealing element is designed as a one-piece, substantially hollow-cylindrical sleeve with a sealing flange and at least one circumferential sealing contour.

2. The add-on housing according to claim 1 wherein the sealing contour is arranged as an annular molding on an outside of the sealing element.

3. The add-on housing according to claim 1 wherein the device for coding is arranged in an interior of the plug-in side.

4. The add-on housing according to claim 1 wherein a flange outer diameter of the sealing flange measures at least 80% of the inner diameter of the device side.

5. The add-on housing according to claim 1 wherein the sealing flange is made of an elastic material, which is connected to an inside of the device side by an integral bond.

6. The add-on housing according to claim 2 wherein the sealing contour is brought into sealing engagement with an inner wall of the high-current plug connector.

7. The add-on housing according to claim 5 wherein the sealing contour has a contact outer diameter that is less than or equal to the flange outer diameter.

8. The add-on housing according to claim 1 wherein the sealing contour flexibly accommodates or encloses the device for coding and seals the device against foreign media.

9. The add-on housing according to claim 1 wherein the electrical plug-in contact has a connection area, a contact area and a fixing area, wherein the connection area is separated from the contact area by the fixing area, and wherein the contact area is substantially cylindrical.

10. The add-on housing according to claim 9 wherein the plug-in contact has a contact protection lock, wherein the contact protect lock is configured for fastening a contact protection device or means.

11. The add-on housing according to claim 1 wherein the sealing element with the sealing flange is arranged on a fixing area and the sleeve encloses at least a quarter of a length of a contact area of the plug-in contact.

12. The add-on housing according to claim 1 wherein the sealing element is introduced into the housing in a primary forming process.

13. The add-on housing according to claim 1 wherein the sealing element is integrally bonded to the plug-in contact in a primary forming process.

14. A plug connector system, comprising:
an electrical add-on housing according to claim 1; and
a corresponding electrical high-current plug connector, wherein the add-on housing is configured to enable mechanical securing of an electrical connection, and wherein the housing of the electrical add-on housing is formed around the electrical plug-in contact in a primary forming process and the high-current plug connector has a plug connector housing and a contact element, wherein the plug connector housing is formed around the contact element in a primary forming process, and
wherein the sealing element of the electrical add-on housing is molded into the add-on housing or onto the electrical plug-in contact by a primary forming process.

15. The plug connector system according to claim 14 wherein the sealing element encloses the at least one device for coding, which is arranged in at least one of the components of the add-on housing or the high-current plug connector, in a sealing manner against foreign media or accommodates the at least one device for coding in a sealing manner against foreign media.

16. A method for producing an add-on housing for receiving an electrical high-current plug connector, the add-on housing comprising at least a housing, an electrical plug-in contact and a sealing element, wherein the housing comprises a device side and a plug-in side, wherein a stop is circumferentially arranged on the housing and the plug-in side comprises at least one fastening device which is configured to be brought into engagement with a fastening form of the high-current plug connector, and wherein the plug-in side further comprises at least one device for coding which prevents a plug-in process with an unsuitable plug connector or a plug-in process with the high-current plug connector in an undesired orientation, the method comprising:
introducing the sealing element between the housing and the plug-in contact in a primary forming process, wherein the sealing element is designed elastically such that the device for coding is sealingly received or sealingly enclosed.
